(19) United States
(12) Patent Application Publication
(10) Pub. No.: US 2008/0298492 A1
(43) Pub. Date: Dec. 4, 2008

(54) Apparatus and Method for Estimating Channel in Communication System Supporting of Dm/Ofdma

(75) Inventors: Yong-suk Hwang, Gyeonggi-do (KR); Hyung-seob Kim, Gyeonggi-do (KR); Kang-Min Lee, Gyeonggi-do (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: POSTDATA CO., LTD., Seongnam-si (KR)

(21) Appl. No.: 12/158,304

(22) PCT Filed: Dec. 29, 2006
(86) PCT No.: PCT/KR2006/005903

§ 371 Date: Jun. 19, 2008

(30) Foreign Application Priority Data
Dec. 31, 2005 (KR) 10-2005-0136295

(51) Int. Cl. H04L 27/28

(52) U.S. Cl. 375/260

(57) ABSTRACT

Disclosed are an apparatus and a method for estimating a channel in a base station when using an Optional Partial Usage of Sub-Channels (OPUSC) mode in an uplink channel of a communication system supporting Orthogonal Frequency Division Multiplexing/Orthogonal Frequency Division Multiple Access (OFDM/OFDMA). In order to estimate the channel in the OFDM/OFDMA communication system, according to the present invention, pilots and data are extracted from input signals, phase change caused by time delay is estimated using the extracted pilots and data, and a channel estimation value is obtained by reflecting the estimated phase change.

### TECHNICAL FIELD

The present invention relates to an apparatus and a method for estimating a channel in a communication system supporting Orthogonal Frequency Division Multiplexing/Orthogonal Frequency Division Multiple Access (OFDM/OFDMA). More particularly, the present invention relates to an apparatus and a method for estimating a channel in a base station when using an Optional Partial Usage of Sub-Channels (OPUSC) mode in an uplink channel of a communication system supporting the OFDM/OFDMA.

### BACKGROUND ART

A Wireless Broadband Internet (WiBro), which is Korean standard of the wireless portable Internet, applies Orthogonal Frequency Division Multiplexing (OFDM) for a signal transmission scheme to enable high-speed data service even in a state where the user is moving in the wireless environment. Additionally, Orthogonal Frequency Division Multiple Access (OFDMA) based on the OFDM is applied to enable a plurality of users to access the Internet simultaneously.

In the communication system supporting OFDM/OFDMA, a transmitter inserts pilots in signals of the frequency domain when performing transmission. The receiver performs channel estimation using the pilots in order to compensate distorted data existing among the pilots. To be more specific, the channel can be estimated by averaging the pilots or by multiplying each pilot by a weight according to the position of the data and summing the multiplied values.

However, when the OPUSC mode is used in the uplink channel of the OFDM/OFDMA communication system, a single pilot is included per tile. Therefore, it is hard to apply a certain method for averaging or interpolating the pilots. Furthermore, although the channel changes along a frequency axis in the frequency domain, the channel change is not easy to be estimated since the only one pilot can be used per tile.

Meanwhile, in the receiver, the channel transmitting a signal in a frequency domain may be changed depending on a position of performing Fast Fourier Transform (FFT) with a received signal. The channel in the frequency domain may be changed depending on a difference in time delay of signal being transmitted by multipath channels in a time domain.

### DISCLOSURE OF INVENTION

### Technical Problem

Therefore, the present invention has been made in view of the above-mentioned problems, and it is an object of the present invention to provide an apparatus and a method for estimating a channel in a communication system supporting Orthogonal Frequency Division Multiplexing/Orthogonal Frequency Division Multiple Access (OFDM/OFDMA) that uses an Optional Partial Usage of Sub-Channels (OPUSC) mode in an uplink channel.

It is another object of the present invention to provide an apparatus and a method for estimating a channel by estimating and compensating a change of phase using pilots, in a communication system supporting OFDM/OFDMA that uses the OPUSC mode in an uplink channel.

### Technical Solution

According to an aspect of the present invention, there is provided an apparatus for estimating a channel in a communication system supporting Orthogonal Frequency Division Multiplexing/Orthogonal Frequency Division Multiple Access (OFDM/OFDMA) using an Optional Partial Usage Sub-Channel (OPUSC) mode, comprising a Radio Frequency (RF) module for converting RF band signals received via antenna to low-frequency band signal; a Fast Fourier Transform (FFT) module for converting time-domain signal of the low-frequency band to frequency-domain signal; a derandomizer for performing derandomization with respect to the frequency-domain signal by using a random sequence used by a transmitter; a depermutation module for performing depermutation to collect tiles of the subchannel transmitted on different sub-carriers output from the derandomizer; and a channel estimation module for extracting pilots and data from the respective tiles of the sub-channel, estimating phase change using the extracted pilots and data, and obtaining a channel estimation value by compensating the estimated phase change.

According to another aspect of the present invention, there is provided a module for estimating a channel in a communication system supporting OFDM/OFDMA using an OPUSC mode, comprising: a phase change estimation unit for extracting pilots and data included in an input signal, and estimating phase change using the extracted pilots and data; and a phase reflection unit for obtaining a channel estimation value by reflecting the phase change estimated by the phase change estimation unit.

According to another aspect of the present invention, there is provided a method for estimating a channel in a communication system supporting OFDM/OFDMA using an OPUSC mode, comprising the steps of: a) converting RF band signals received via antenna to low-frequency band signal; b) converting time-domain signal of the low frequency band to frequency-domain signal; c) derandomizing the frequency-domain signal based on using a random sequence used by a transmitter; d) collecting tiles of the sub-channel for derandomized signal being transmitted on different sub-carriers; e) extracting pilots and data from the respective tiles of the sub-channel, and estimating phase change using the extracted pilots and data; and f) obtaining a channel estimation value by reflecting the estimated phase change.

According to another aspect of the present invention, there is provided a method for estimating a channel in a communication system supporting OFDM/OFDMA using an OPUSC mode, comprising the steps of: a) extracting data and pilot included in respective tiles of the signal input by the sub-channel; b) obtaining a temporary channel estimation value using the extracted pilots; c) compensating the channel of the data using the temporary channel estimation value, and determining a temporary phase information value with respect to the channel-compensated data; d) compensating the phase information of the data by the temporary phase information value; and e) estimating the phase change based on the phase-information-compensated data.

### ADVANTAGEOUS EFFECTS

According to the present invention, phase change estimated by a channel estimation module using pilots and data is compensated in a channel compensation module. As a result, phase change of a received signal caused by time delay can be removed.

Additionally, more accurate estimation of the phase change can be achieved by estimating the phase change by the sub-channel.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a structural view of a logical signal being transmitted when an Optional Partial Usage of Sub-Channels (OPUSC) mode is used in an uplink channel of a communication system supporting Orthogonal Frequency Division Multiplexing/Orthogonal Frequency Division Multiple Access (OFDM/OFDMA);

FIG. 2 is a structural view of a channel estimation apparatus applied to the communication system supporting the OFDM/OFDMA according to an embodiment of the present invention;

FIG. 3 is a detailed structural view of a channel estimation module of FIG. 2;

FIG. 4 is a detailed structural view of a phase change estimation unit of FIG. 3;

FIG. 5 is a structural view of a tile used in the OPUSC mode; and

FIG. 6 is a flow chart explaining a method for estimating a channel in the communication system supporting OFDM/OFDMA according to an embodiment of the present invention.

### MODE FOR THE INVENTION

Hereinafter, an exemplary embodiment of the present invention will be described in detail with reference to the accompanying drawings. Well known functions and constructions are not described in detail since they would obscure the invention in unnecessary detail.

Reference will now be made in detail regarding exemplary embodiments of the present invention.

Channel estimation apparatus and method according to the present invention are applicable to a receiver and a transceiver. According to the embodiments of the present invention, especially, channel estimation is performed in a communication system supporting Orthogonal Frequency Division Multiplexing/Orthogonal Frequency Division Multiple Access (OFDM/OFDMA) that uses an Optional Partial Usage of Sub-Channels (OPUSC) mode in an uplink channel. Therefore, a Radio Access Station (RAS) serving as a base station can be applied for the receiver or the transceiver.

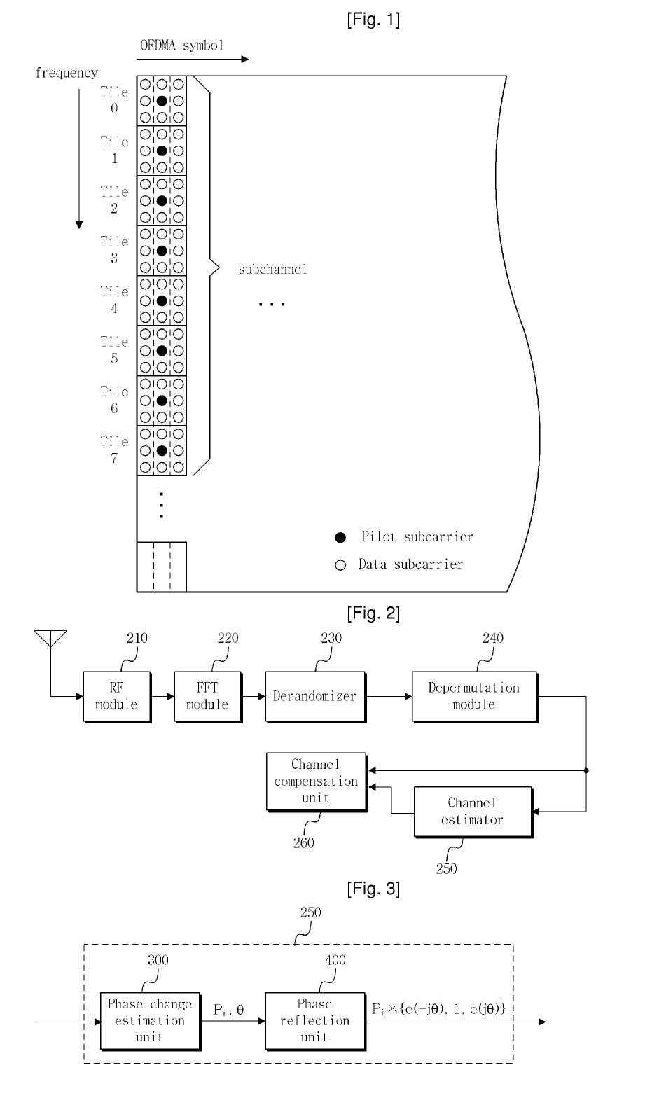

FIG. 1 shows a logical structure of a signal being transmitted when using the OPUSC mode in the uplink channel, in the communication system supporting the OFDM/OFDMA.

Referring to FIG. 1, one sub-channel comprises 8 tiles and each tile comprises 1 pilot and 8 data. Each sub-channel covers 3 OFDMA symbols. The logical signal is loaded and transmitted on respectively different sub-carriers respectively different in the tile.

As shown in FIG. 2, the channel estimation apparatus according to an embodiment of the present invention comprises a Radio Frequency (RF) module 210, a Fast Fourier Transform (FFT) module 220, a derandomizer 230, a depermutation module 240, a channel estimation module 250, and a channel compensation module 260.

The RF module 210 converts RF band signals received via antenna to low-frequency band signal. The FFT module 220 converts the low-frequency band signal of a time domain to a frequency domain signal. The derandomizer 230 performing derandomization with respect to the frequency-domain signals converted by the FFT module 220, by using a random sequence used by a transmitter when transmitting the RF band signals. The depermutation module 240 collects, by the sub-channel, the tiles transmitted along with the respectively different sub-carriers. The signal collected by the sub-channel is input to the channel estimation module 250. An estimated value in the channel estimator 250 is input to the channel compensation module 260 to be used in compensating the channel. The signal input to the channel estimation module 250 is processed by the sub-channel. As shown in FIG. 1, the tiles constituting the sub-channel are transmitted along with respectively different sub-carriers. Accordingly, time delay is incurred and a phase change is caused on the respective sub-carriers. According to the present invention, channel estimation can be achieved by estimating the phase change.

Especially, hereinafter, the present invention will be described mainly about the channel estimation module 250, while omitting explanation of generally known elements.

Referring to FIG. 3, the channel estimation module 250 to estimate the channel in the OFDM/OFDMA communication system using the OPUSC mode in the uplink channel comprises a phase change estimation unit 300 and a phase reflection unit 400. The phase change estimation unit 300 extracts pilots and data from signals input by the sub-channel, and estimates phase change that increases and decreases along a frequency axis, by the sub-channel. The phase reflection unit 400 reflects the estimated phase to the pilots.

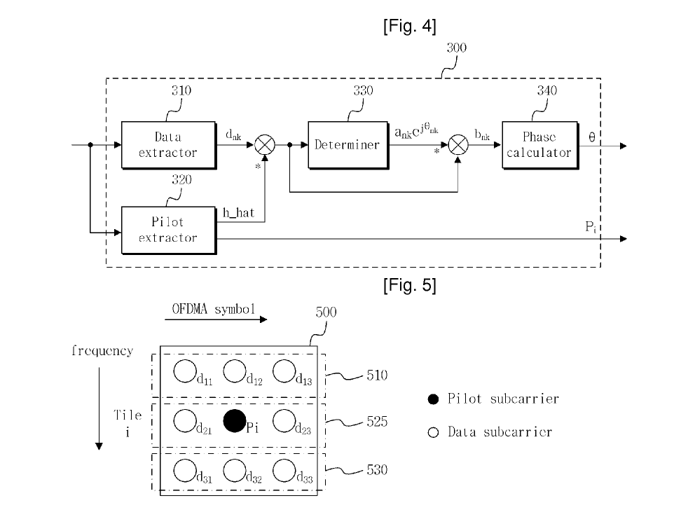

FIG. 4 is a detailed view showing the structure of the phase change estimation unit 300 of FIG. 3.

As shown in FIG. 4, the phase change estimation unit comprises a data extractor 310, a pilot extractor 320, a determiner 330, and a phase calculator 340.

First of all, structure of the tile used in the OPUSC mode will be briefly described with reference to FIG. 5. In the OFDM/OFDMA communication system, when the OPUSC mode is used in the uplink channel, the transmitted sub-channel comprises 8 tiles. Each tile has a 3×3 matrix structure comprising 1 pilot P in the center and 8 data (dₙₖ; d₁₁, d₁₂, d₁₃, d₂₁, d₂₃, d₃₁, d₃₂, d₃₃) symmetrically surrounding the pilot. One sub-channel covers 3 OFDM symbols. In the sub-channel, each sub-carrier has a phase change due to time delay τ.

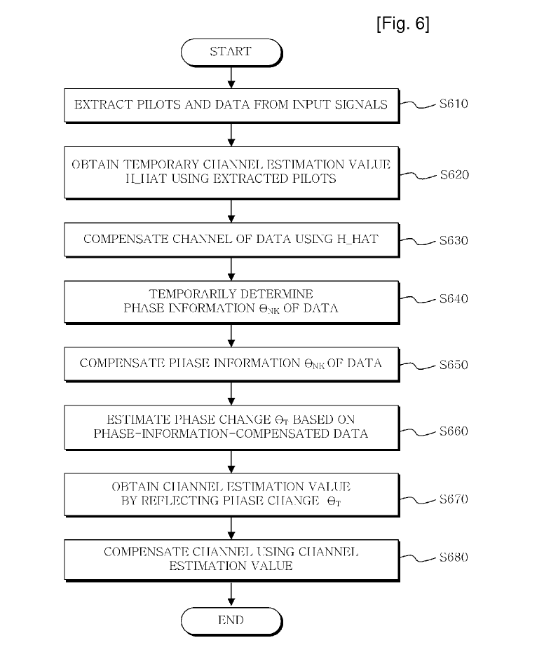

Hereinafter, an apparatus and a method for estimating the channel in the OFDM/OFDMA communication system using the OPUSC mode according to the present invention will be described with reference to FIGS. 3, 4 and 6.

The data extractor 310 extracts the data dₙₖ from the signalinput by the sub-channel, and outputs the extracted data dₙₖ (S610). The data can be expressed by [Equation 1] as below:

dₙₖ>aₙₖe^{jθ}^{ₙₖ}×h×e^{jnθ} [Equation 1]

wherein, ′

aₙₖe^{-jθ}^{ₙₖ}

′ denotes a transmission signal located at an n-th sub-carrier (n=1, 2, 3) and a k-th symbol (k=1, 2, 3) in a tile, and ‘h’ denotes a channel response. Average power of ‘aₙₖ’ is 1.

The pilot extractor 320 extracts the pilot signal Pᵢ from the input signal (S610). The pilot can be expressed, for example, by [Equation 2] as below:

$${P}_{i} = h \times {e}^{j l θ} \times \frac{4}{3} \qquad [ Equation 2 ]$$

wherein, ‘l’ denotes a location of the pilot. The pilot extractor 320 obtains a temporary channel ‘h_hat’ using the extracted pilot Pᵢ (S620). For example, a temporary channel estimation value ‘h_hat’ can be obtained by [Equation 3] as below:

h_hat=Pᵢ×(¾),(i=0,1,2, . . . 7) [Equation 3]

The channel of each data is compensated using the temporary channel estimation value ‘h_hat’ (S630), in which each data includes phase information of the data θₙₖ (data value) and phase change θ_{τ} by the time delay. In this embodiment, the phase information of the data representing the data value is removed first. In other words, data components are removed from each data signal. And then, the phase change θ_{τ} by the time delay is estimated. The determiner 330 temporarily determines a phase information value with respect to the data compensated by the temporary channel estimation value ‘h_hat’ (S640). The temporary data phase information value is determined according to the modulation method. For example, when Quadrature Phase Shift Keying (QPSK) modulation is applied, the temporary phase information value is determined as one of π/4, 3π/4, −π/4, −3π/4. Next, the phase information of the data is compensated using the temporarily determined phase information value (S650). Thus compensated output value bₙₖ can be expressed by [Equation 4] as below:

bₙₖ=dₙₖ×h_hat*×(aₙₖe^{-jθ})=|h|²|aₙₖ|²e^{j(θn)} [Equation 4]

After compensating the phase information of the data, only the phase change θ_{τ} by the time delay is left in the output value bₙₖ. The phase change calculator 340 estimates the remaining phase change by the time delay. More specifically, the phase change calculator 340 performs conjugation-multiplication with data located on the frequency axis, and accumulates the result value. The phase difference between two sub-carriers 510 and 530 (FIG. 5) is obtained by performing arctan-operation, for example. An average phase change is obtained by dividing the phase difference by 2 (S660). Here, ‘2’, the multiplying number, denotes positional difference between the sub-carriers. For example, data d₁₁ belonging to the sub-carrier 510 and data d₂₁ belonging to a sub-carrier 520 are distanced from each other by 1 sub-carrier. The data d₁₁ of the sub-carrier 510 and data d₃₁ of the sub-carrier 530 are distanced from each other by 2 sub-carriers.

[Equation 5] expresses the result value of the phase change estimation unit 300 through the above procedures, as follows:

$${θ}_{τ} = \frac{1}{2} arctan \{ {\sum }_{i = 0}^{7} ( \begin{matrix}{b}_{i , 11} \times {b}_{i , 31}^{*} + {b}_{i , 12} \times \\ {b}_{i , 32}^{*} + {b}_{i , 13} \times {b}_{i , 33}^{*}\end{matrix} ) \} \qquad [ Equation 5 ]$$

The phase reflection unit 400 reflects the phase change θ_{τ} by the time delay to the pilot Pᵢ extracted by the phase change estimation unit 300, thereby obtaining a channel estimation value for compensating data (S670). Data included in the same sub-carrier in one tile are compensated using the same channel estimation value. The channel estimation value of the sub-carrier for compensating data is determined in the following manner.

The channel estimation value corresponding to the first sub-carrier is Pᵢ×exp(−jθ), the second sub-carrier is Pᵢ×1, and the third sub-carrier is Pᵢ×exp(jθ). The channel estimation value is transmitted to the channel compensation module 260. The channel compensation module 260 reflects the channel estimation value to the signal output from the depermutation module 240, accordingly compensating the channel (S680).

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. An apparatus for estimating a channel in a communication system supporting Orthogonal Frequency Division Multiplexing/Orthogonal Frequency Division Multiple Access (OFDM/OFDMA) using an Optional Partial Usage Sub-Channel (OPUSC) mode, comprising:
a Radio Frequency (RF) module for converting RF band signals received via antenna to low-frequency band signal;
a Fast Fourier Transform (FFT) module for converting time-domain signal of the low-frequency band to frequency-domain signal;
a derandomizer for performing derandomization with respect to the frequency-domain signal by using a random sequence used by a transmitter;
a depermutation module for performing depermutation to collect tiles of the subchannel transmitted on different sub-carriers output from the derandomizer; and
a channel estimation module for extracting pilots and data from the respective tiles of the sub-channel, estimating phase change using the extracted pilots and data, and obtaining a channel estimation value by compensating the estimated phase change.

2. An apparatus of claim 1, further comprising a channel compensation module for compensating the channel by reflecting the channel estimation value to signal output from the depermutation module.

3. An apparatus of claim 1, wherein the channel estimation module obtains a temporary channel estimation value using the extracted pilots, compensates the channel of the data using the temporary channel estimation value, compensates phase information of the data by reflecting a temporary phase information value to the channel-compensated data, and estimates the phase change based on the phase-information-compensated data.

4. An apparatus of claim 1, wherein the tile has a 3×3 matrix structure comprising 1 pilot and 8 data symmetrically surrounding the pilot.

5. An apparatus of claim 1, being implemented by a wireless communication receiver or a wireless communication transceiver.

6. A module for estimating a channel in a communication system supporting OFDM/OFDMA using an OPUSC mode, comprising:
a phase change estimation unit for extracting pilots and data included in an input signal, and estimating phase change using the extracted pilots and data; and
a phase reflection unit for obtaining a channel estimation value by reflecting the phase change estimated by the phase change estimation unit.

7. The module of claim 6, wherein the phase change estimation unit estimates the phase change by the sub-channel.

8. The module of claim 6, wherein the phase change estimation unit comprises:
a data extractor for extracting data included in respective tiles of the input signal;
a pilot extractor for extracting pilots included in the respective tiles of the input signal, and obtaining a temporary channel estimation value using the extracted pilots;
a determiner for determining a temporary phase information value with respect to the channel-compensated data according to a data modulation scheme to compensate the channel of the data using the temporary channel estimation value; and
a phase calculator for performing conjugation-multiplication with respect to data pairs, in which the data pairs is compensated for the phase information by the temporary phase information, positioned on the same symbol of one tile and transmitted on different sub-carriers, accumulating the conjugation-multiplication result, and estimating the phase change based on the accumulation result.

9. The module of claim 8, wherein the phase calculator estimates the phase change by performing arctan-operation with respect to the accumulation result and dividing the arctan-operation result by a value corresponding to positional difference between the sub-carriers including the respective data.

10. A method for estimating a channel in a communication system supporting OFDM/OFDMA using an OPUSC mode, comprising the steps of:
a) converting RF band signals received via antenna to low-frequency band signal;
b) converting time-domain signal of the low frequency band to frequency-domain signal;
c) derandomizing the frequency-domain signal based on using a random sequence used by a transmitter;
d) collecting tiles of the sub-channel for derandomized signal being transmitted on different sub-carriers;
e) extracting pilots and data from the respective tiles of the sub-channel, and estimating phase change using the extracted pilots and data; and
f) obtaining a channel estimation value by reflecting the estimated phase change.

11. The method of claim 10, further comprising a step of:
g) compensating the channel of the signal using the channel estimation value.

12. The method of claim 10, wherein the step e) obtains a temporary channel estimation value using the extracted pilots, compensates the channel of the data using the temporary channel estimation value, determines a temporary phase information value with respect to the channel-compensated data, compensates phase information of the data using the temporary phase information value, and estimates the phase change based on the phase-information-compensated data.

13. The method of claim 10, wherein the tile has a 3×3 matrix structure comprising 1 pilot and 8 data symmetrically surrounding the pilot.

14. A method for estimating a channel in a communication system supporting OFDM/OFDMA using an OPUSC mode, comprising the steps of:
a) extracting data and pilot included in respective tiles of the signal input by the sub-channel;
b) obtaining a temporary channel estimation value using the extracted pilots;
c) compensating the channel of the data using the temporary channel estimation value, and determining a temporary phase information value with respect to the channel-compensated data;
d) compensating the phase information of the data by the temporary phase information value; and
e) estimating the phase change based on the phase-information-compensated data.

15. The method of claim 14, further comprising a step of:
f) obtaining a channel estimation value by reflecting the estimated phase change.

16. The method of claim 14, wherein the step e) comprises the steps of:
e-1) performing conjugation-multiplication with respect to data pairs, in which the data pairs is compensated for the phase information by the temporary phase information, positioned on the same symbol of one tile and transmitted on different sub-carriers;
e-2) accumulating the conjugation-multiplication result; and
e-3) estimating the phase change based on the accumulation result.

17. The method of claim 16, wherein the step e-3) estimates the phase change by performing arctan-operation with respect to the accumulation result and dividing the arctan-operation result by a value corresponding to difference between the sub-carriers including the respective data.
